(19) United States
(12) Patent Application Publication
(10) Pub. No.: US 2025/0074700 A1
(43) Pub. Date: Mar. 6, 2025

(54) Support Element For A Segment Of Wind Turbine Towers, Support System Comprising At Least A Support Element And Method Of Supporting At Least A Segment Of Wind Turbine Towers

(71) Applicant: NORDEX ENERGY SPAIN, S.A.U., Navarra (ES)

(72) Inventors: Vanessa CERRILLO GÓMEZ, Navarra (ES); Unai ARRAZTOA MAGAÑA, Navarra (ES)

(21) Appl. No.: 18/724,924

(22) PCT Filed: Dec. 1, 2022
(86) PCT No.: PCT/EP2022/084100

§ 371 Date: Jun. 27, 2024

(30) Foreign Application Priority Data
Dec. 30, 2021 (EP) 21383237.1

(51) Int. Cl. B65G 1/04; F03D 13/20

(52) U.S. Cl. CPC B65G 1/04; F03D 13/201; F05B 2240/912

(57) ABSTRACT

The present invention relates to a support element for a segment of wind turbine towers which avoids damage of the segment while the segment is supported or stacked, a support system comprising at least a support element which provides a competitive advantage that allows to reduce the space necessary for storing the segments or to allow more segments to be stored in the same space, and a method of supporting at least a segment of wind turbine towers.

### OBJECT OF THE INVENTION

The present invention relates to a support element for a segment of wind turbine towers which avoids damage of the segment while the segment is supported or stacked.

The object of the present invention is also a support system comprising at least a support element which provides a competitive advantage that allows to reduce the space necessary for storing the segments or to allow more segments to be stored in the same space without interferences between the segments, by maximizing the number of segments that can be stored under a maximum predetermined height.

Another object of the present invention is a method of supporting at least a segment of wind turbine towers.

### BACKGROUND OF THE INVENTION

The towers that support wind turbines in wind farms, both on-shore and off-shore, are made up of several segments that are joined together at their ends to reach the required nacelle height. In turn, the tower is formed by the lateral assembly of several pieces, commonly known as “voussoirs” or segments, giving rise to a tower of truncated cone or cylindrical geometry.

The materials used for the construction of voussoirs or segments can be very diverse, although most commonly they are made of steel or concrete. The variability existing on the market in terms of geometries and weights of these elements depends on the manufacturer, so there are many different types.

The known support systems for the stockpiling and transport of segments are based on the support of the segment by its central generatrix on a horizontal surface and on the wedging of the segment on both sides of the central generatrix to prevent its displacement.

In concrete tower factories, segments are stacked with blocks that allow to stack more than two segments.

The disadvantage of these systems is that it is necessary to gradually place wedges on both sides of the central generatrix until the segment is centred and balanced.

In addition, these systems are very unstable, as the slightest movement can cause one of the wedges to move and consequently the segment to shift, potentially damaging the segments.

The support element for a segment of wind turbine towers of the present invention can be used for the stockpiling of segments in the factory and solves the above-mentioned disadvantages.

### DESCRIPTION OF THE INVENTION

The present invention relates to a support element for a segment of wind turbine towers which prevents any damage to the segment while the segment is supported or stacked.

The support element comprises:
a main body which in turn comprises an upper surface, wherein the upper surface of the main body comprises a central zone and two lateral zones;
at least two first protective elements, each one configured to be attached to one lateral zone of the lateral zones of the upper surface of the main body; and
   wherein the at least two first protective elements are configured, in use, to support at least one first segment having a first geometry.

In this way, at least one protective element is attached to each of the two lateral zones of the upper surface, so that the at least one first segment having a first geometry rests on them.

Preferably, the main body is made of concrete. In this way, the main body has a high resistance to compression. Also preferably, the segment of a wind turbine is a concrete segment. In this way, the support elements and the segments can be manufactured in the same concrete factory, thus providing advantages in terms of cost and convenience.

Optionally, the upper surface is a concave surface.

Optionally, the central zone is a horizontal surface. Optionally, the two lateral zones are two inclined surfaces. Preferably, the two lateral zones are symmetrically disposed with regard to a central longitudinal axis of the support element, the central longitudinal axis being parallel to the upper surface. More preferably, the two lateral zones are adjacent to the central zone.

Optionally, the main body of the support element further comprises a lower surface. Optionally, the lower surface comprises at least a central zone and two lateral zones. The lower surface is configured to provide a base for the support element.

The distance between the central zone of the upper surface and the central zone of the lower surface can be defined as a central thickness.

The distance between each one of the two lateral zones of the upper surface and each one of the opposed two lateral zones of the lower surface can be defined as a lateral thickness.

Preferably, the central thickness is smaller than the lateral thickness. This has the advantageous effect of reducing the amount of concrete to be used in the support element while at the same time achieving the effect of stacking the segments using the minimum height without interferences between them.

In a first embodiment, the lower surface of the main body of the support element is configured to be disposed, in use, on the ground. Preferably, the lower surface of the main body of the support element is configured to be disposed, in use, on a foundation. Preferably the lower surface comprises a planar surface.

In a second embodiment, the main body of the support element further comprises a lower surface, wherein the lower surface comprises at least a central zone and two lateral zones, and the support element further comprises at least two second protective elements, each one configured to be attached to one lateral zone of the two lateral zones of the lower surface of the main body, and wherein the at least two second protective elements are configured, in use, to be disposed on the at least one first segment having the first geometry

Preferably, in the second embodiment the lower surface is a convex surface. Also preferably, the central zone of the lower surface is a horizontal surface and the two lateral zones of the lower surface are two inclined surfaces. Preferably, the two lateral surfaces are symmetrically disposed with regard to a central longitudinal axis of the support element. More preferably, the two lateral zones are adjacent to the central zone.

Optionally, the central zone of the upper surface is parallel to the central zone of the lower surface and the two lateral zones of the upper surface are respectively parallel to the two lateral zones of the lower surface.

Optionally, the at least two second protective elements are at least partially disposed in a vertical projection of the at least two first protective elements in such a way that the reaction forces transmitted to the segment by the at least two second protective elements and by the at least two first protective elements in both sides of the segment are aligned such that substantially no shear stresses are created within the segment.

Optionally, the at least one first protective element is configured to be attached to the upper surface of the main body in a detachable manner.

Optionally, the at least one second protective element is configured to be attached to the lower surface of the main body in a detachable manner.

Preferably, the at least two first protective elements are disposed in a symmetrical position with regard to the central longitudinal axis of the support element.

Preferably, the at least two second protective elements are disposed in a symmetrical position with regard to the central longitudinal axis of the support element.

Preferably, each one of the at least two first protective elements are disposed in one lateral zone of the two lateral zones of the upper surface of the main body.

Optionally, the first protective elements and/or the second protective elements comprises an elastomer. The elastomer is selected from polychloroprene, ethylene propylene diene monomer (EPDM), polyisoprene, polybutadiene, styrene-butadiene rubber, butyl rubber, nitrile rubber, Ethylene-propylene rubber (EPM), Ethylene Rubber-Vinyl Acetate (EVM), Fluorinated rubber (FKM), Acrylic rubber (ACM), Chlorinated polyethylene (CM), Chlorosulfur polyethylene (CSM), polyamide and polyester copolymer, Epichlorohydrin rubber (ECO), Silicone rubber (MQ), Polyurethane elastomers (AU and EU), Polysulfide rubber or a combination of them. The presence of an elastomer in the supporting surface of the protective element results in the capacity of reducing damages in the surface of the segment, and, in the case of curved segments, of adapting to the curvature of the surface of the tower segment.

Preferably, the first protective element or elements and/or the second protective element or elements comprises a thermoplastic elastomer. Preferably, the elastomer is a reinforced elastomer. In a first embodiment, the reinforced elastomer comprises steel sheets bonded to the elastomer, by example in a vulcanisation process. In a second embodiment, the reinforced elastomer comprises steel particles embedded in the elastomer, by example in a vulcanisation process. Due to this, the protective element has a high resistance to compression and shear stresses.

More preferably, the first and second protective elements comprise an elastomer which optionally comprises steel sheets bonded to the elastomer. More preferably, the elastomer is polychloroprene reinforced with embedded steel sheets. The difference between the summatory of the lateral thickness and the thickness of the first and/or second protective elements with respect to the central thickness allows to stack the tower segments in the minimum possible height without damage or interferences between them.

The summatory of the thickness of the lateral thickness and the thickness of the first and/or second protective elements may optionally be between 0.05*R and 1*R, more preferably between 0.1*R and 0.8*R and even more preferably between 0.15*R and 0.7*R, wherein R is the radius of the tower segment in a segmented tower of a circular cross-section wherein the segments are curved segments, supported, in use, by the support elements described above.

The invention also relates to a support system comprising:
one support element according to the first embodiment;
at least one support element according to the second embodiment;
one first segment of wind turbine towers, wherein the one first segment is supported by means of the at least two first protective elements of the one support element according to the first embodiment,
wherein the at least two second protective elements of the at least one support element according to the second embodiment are disposed on the at least one first segment having the first geometry; and
at least one additional first segment of wind turbine towers, wherein the at least one additional first segment is supported by means of the at least two first protective element of the at least one support element according to the second embodiment.

In this way, the support system avoids damage of the one first segment while the segment is supported or stacked.

Optionally, the one first segment and the at least one additional first segment is curved or planar.

Optionally, the support system further comprises a foundation configured to support the one support element according to the first embodiment, the at least one support element according to the second embodiment and the at least one first segment and the at least one additional first segment having the first geometry.

Preferably, the at least two second protective elements of the at least one support element as the one described for the second embodiment is also configured to be disposed on the one first segment having the first geometry.

So configured, the support system allows to stack more than two segments of wind turbines avoiding the damage of the segments, reducing the space required for storing or stacking segments or to allow more segments to be stored or stacked in the same floor area.

Preferably, the at least two support elements are disposed in a symmetrical position with regard to a central section of the at least one first segment defined in a plane perpendicular to a longitudinal direction of the at least one first segment.

Optionally, the support system comprises:
two support elements as the ones described for the first embodiment;
at least two support elements as the ones described for the second embodiment;
wherein the at least one first segment is supported by means of the at least two first protective elements of each of the two support elements according to the first embodiment; and
wherein the at least one additional first segment is supported by means of the at least two first protective elements of the at least two support elements according to the second embodiment.

So configured, the support system provides a competitive advantage that allows to reduce the necessary area for storing the segments or to allow more segments to be stored in the same area.

Preferably, the two support elements as the ones described for the first embodiment and/or the at least two support elements as the ones described for the second embodiment are disposed in a symmetrical position with regard to a central section of the one first segment and/or the at least one additional first segment defined in a plane perpendicular to a longitudinal direction of the one first segment and the at least one additional first segment.

Preferably, the central thickness is smaller than the lateral thickness.

In a segmented tower of a circular cross-section the segments are curved segments. In such a case, in the support system of the present invention described above, the at least one first segment and the at least one additional first segment are curved, wherein the difference between the summatory of the lateral thickness and the thickness of the first and/or second protective elements with respect to the central thickness for the two support elements as the one described for the first embodiment and for the at least two support elements as the ones described for the second embodiment allows to stack the tower segments in the minimum possible height without damage or interferences between the curved segments or between the support elements and the lowest most part of the curved segments. The summatory of the lateral thickness and the thickness of the first and/or second protective elements may optionally be between 0.05*R and 1*R, more preferably between 0.1*R and 0.8*R and even more preferably between 0.15*R and 0.7*R, wherein R is the radius of the tower segment in order to optimize the total occupied volume and avoid the abovementioned interferences.

The invention also relates to a method of supporting at least a segment of wind turbine towers carried out with the support system described above, wherein the method comprises the steps of:
attaching each one of the at least two first protective elements to one lateral zone of the upper surface of the main body of the one or two support elements according to the first embodiment;
disposing the one first segment on the at least two first protective elements of the one or two support elements according to the first embodiment;
attaching each one of the at least two second protective elements to one lateral zone of the lower surface of the main body of the at least one or at least two support elements according to the second embodiment;
disposing the at least one or at least two support elements according to the second embodiment on the one first segment;
attaching each one of the at least two first protective elements to one lateral zone of the upper surface of the main body of the at least one or at least two support elements according to the second embodiment; and
disposing the at least one additional first segment on the at least two first protective elements of the at least one or at least two support elements according to the second embodiment.

Optionally, the method further comprises a step of:
casting a foundation in a stockpiling area;
disposing the one or two support elements according to the first embodiment on the foundation;

wherein the step of disposing the one or two first segments on the at least two first protective elements of the one or two support elements according to the first embodiment is carried out after the step of disposing the one or two support elements according to the first embodiment on the foundation.

Optionally, the method comprises the following steps:
calculating the dimensions of the support elements according to the first and second embodiment and the dimensions of the protective elements in respect of the dimensions of the tower segments to be stockpiled.
manufacturing the support elements with said dimensions.

### BRIEF DESCRIPTION OF THE DRAWINGS

FIG. 1 shows the support element of the invention according to the first preferred embodiment wherein the first protective elements comprise an ethylene propylene diene monomer elastomer, showing in a detail A the first protective element.

FIG. 2 shows the support element of the invention according to the second preferred embodiment wherein the first protective elements and the second protective elements comprise an ethylene propylene diene monomer elastomer.

FIGS. 3 and 4 show the steps of the method of supporting at least a segment of wind turbine towers carried out with the support system of the present invention.

FIGS. 5 and 6 show additional steps of the method of supporting at least a segment of wind turbine towers carried out with the support system comprising one support element according to the first preferred embodiment as shown in FIG. 1 and one support element according to the second preferred embodiment as shown in FIG. 2, for stacking two segments of wind turbine towers.

FIG. 7 shows the support system of the present invention comprising one support element according to the first preferred embodiment as shown in FIG. 1 and three support elements according to the second preferred embodiment as shown in FIG. 2, for stacking four segments of wind turbine towers.

FIG. 8 shows a section AA of FIG. 7.

FIG. 9 shows a plan view of FIG. 1 or FIG. 2.

FIG. 10 shows the support element of the invention according to the first preferred embodiment wherein the first protective elements comprise a polychloroprene elastomer.

FIG. 11 shows the support element of the invention according to the second preferred embodiment wherein the first protective elements and the second protective elements comprise a polychloroprene elastomer, showing in a detail B the first protective element.

FIG. 12 shows the support system of the present invention comprising one support element according to the first preferred embodiment as shown in FIG. 10 and four support elements according to the second preferred embodiment as shown in FIG. 11, the system being configured to support at least four segments, preferably at least five segments below a maximum predetermined height defined by a hoisting system or crane.

FIG. 13 shows a plan view of the protective element shown in the detail B of FIG. 11.

FIG. 14 shows a view in perspective of the reinforced elastomer of the protective element shown in detail B, wherein a part of the elastomer has been removed to show the steel sheets bonded to the elastomer.

### PREFERRED EMBODIMENT OF THE INVENTION

The invention is described in detail as follows. It relates to a support element (1, 2) for a segment (11, 12) of wind turbine towers, wherein the support element comprises:
a main body (3, 4) which in turn comprises an upper surface (5, 6), wherein the upper surface (5, 6) of the main body (3, 4) comprises a central zone (9, 10) and two lateral zones (13, 14);
at least two first protective elements (7, 8), each one configured to be attached to one lateral zone (13, 14) of the two lateral zones (13, 14) of the upper surface (5, 6) of the main body (3, 4); and
   wherein the at least two first protective elements (7, 8) are configured, in use, to support at least one first segment (11, 12) having a first geometry.

Preferably, the main body (1, 2) is made of concrete, and more preferably of reinforced concrete. It can hence be manufactured in the same manufacturing facility as the concrete segments.

As shown in FIGS. 1, 2, 10 and 11 for the first and second preferred embodiments of support element (1, 2), the central zone (9, 10) is a horizontal surface and the two lateral zones (13, 14) are two inclined surfaces, and wherein the two lateral zones (13, 14) are symmetrically disposed with regard to a central longitudinal axis (20) of the support element (1, 2), the central longitudinal axis (20) being parallel to the central zone (9) of the upper surface (5, 6). More preferably, the two lateral zones (13, 14) are adjacent to the central zone (9, 10). Even more preferably, a central thickness (t1 ) between opposing central zones (9, 10) is smaller than a lateral thickness (t2 ) between opposing lateral zones (13, 14), and the upper surface (5, 6) of the support element (1, 2) is preferably a concave surface.

Additionally, the main body (3, 4) of the support element (1, 2) further comprises a lower surface (15, 16).

In the first embodiment shown in FIGS. 1 and 10, the lower surface (15) of the main body (3) of the support element (1) is configured to be disposed, in use, on a foundation (21), wherein the lower surface (15) comprises a planar surface.

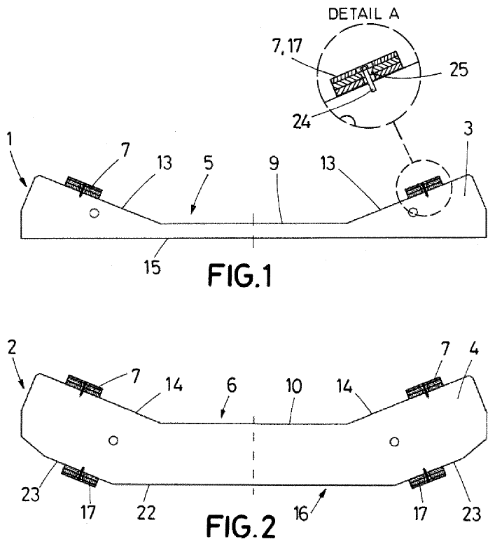

In the second embodiment shown in FIGS. 2 and 11, the main body (3) of the support element (2) further comprises a lower surface (16), wherein the lower surface (16) comprises at least a central zone (22) and two lateral zones (23), and
the support element (2) further comprises:
at least two second protective elements (17, 18), each one configured to be attached to one lateral zone (23) of the two lateral zones (23) of the lower surface (16) of the main body (4), and
   wherein the at least two second protective elements (17, 18) are configured, in use, to be disposed on the at least one first segment (11, 12) having the first geometry.

Preferably, the central zone (22) of the lower surface (16) is a horizontal surface and the two lateral zones (23) of the lower surface (16) are two inclined surfaces, wherein the two lateral zones (23) are symmetrically disposed with regard to a central longitudinal axis (20) of the support element (2). More preferably, the two lateral zones (23) of the lower surface (16) are adjacent to the central zone (22). Preferably, the central zone (10) of the upper surface (6) is parallel to the central zone (22) of the lower surface (16) and the two lateral zones (14) of the upper surface (6) are respectively parallel to the two lateral zones (23) of the lower surface (16). Even more preferably, the central thickness (t1) between opposing central zones (10, 22) is smaller than the lateral thickness (t2) between opposing lateral zones (14, 23), and the lower surface (16) is preferably a convex surface.

For the embodiments shown in FIGS. 2 and 11, the at least two second protective elements (17, 18) are at least partially disposed in a vertical projection of the at least two first protective elements (7, 8). Preferably, the at least two first protective elements (7, 8) and the at least two second protective elements (17, 18) comprise a central vertical axis (40), wherein the central vertical axis (40) is common for the at least two first protective elements (7, 8) and the at least two second protective elements (17, 18) for each of the protective elements (7, 8) disposed at each side of the central longitudinal axis (20) of the support element (2).

In the embodiments shown in FIGS. 1, 2, 10 and 11, the support element (1, 2) comprises at least two first protective elements (7, 8) disposed in a symmetrical position with regard to the central longitudinal axis (20) of the support element (1, 2) that are configured to be attached to the upper surface (5, 6) of the main body (3, 4), wherein the at least two first protective elements (7, 8) are configured, in use, to support the at least one first segment (11, 12) of wind turbine towers. Also, for the embodiments shown in FIGS. 2 and 11, the support element (2) comprises at least two second protective elements (17, 18) disposed in a symmetrical position with regard to the central longitudinal axis (20) of the support element (2) that are configured to be attached to the lower surface (16) of the main body (4), wherein the at least two second protective elements (17, 18) are also configured to be disposed, in use, on a second segment (11) of wind turbine towers.

For the embodiments shown in FIGS. 1 and 10, the distance between each one of the two lateral zones (14) of the upper surface (6) and the two lateral zones (23) of the lower surface (16) is greater than the distance between the central zone (10) of the upper surface (6) and the central zone (22) of the lower surface (16). This has the advantageous effect of reducing the amount of concrete to be used while at the same time achieving the effect of stacking the segments without interferences between them.

Optionally, the lateral thickness (t2) is between 5 and 1 times the central thickness (t1).

Optionally, the lateral thickness (t2) is between 3.5 and 1 times the central thickness (t1).

Optionally, the lateral thickness (t2) is between 2.5 and 1 times the central thickness (t1).

For the embodiments shown in FIGS. 2 and 11, the distance between each one of the two lateral zones (14) of the upper surface (6) and each one of the opposed two lateral zones (23) of the lower surface (16) is greater than the distance between the central zone (10) of the upper surface (6) and the central zone (22) of the lower surface (16). This has the advantageous effect of reducing the amount of concrete to be used while at the same time achieving the effect of stacking the segments without interferences between them.

Preferably, the ratio between the lateral thickness (t2) and the thickness (t3) of the first protective elements (7, 8) and/or the ratio between the lateral thickness (t2) and the thickness (t3) of the second protective elements (17, 18) is greater than 3.

Preferably, the thickness (t3) of the first protective elements (7, 8) and the thickness (t3) of the second protective elements (17, 18) is the same in support elements (2) configured to support segments (12) having the same geometry.

Preferably, the ratio between the lateral thickness (t2) of a support element (2) and the thickness of the segments (12) that the support element (2) is configured to support is greater than 2.

Optionally, the lateral thickness (t2) is between 1.5 and 1 times the central thickness (t1).

Optionally, the lateral thickness (t2) is between 1.3 and 1.1 times the central thickness (t1).

Optionally, the lateral thickness (t2) is between 1.25 and 1.2 times the central thickness (t1).

For the embodiments shown in FIGS. 1, 2, 10 and 11, the two lateral zones (13, 14) of the upper surface (5, 6) and the central zone (9, 10) of the upper surface (5, 6) are planar.

For the embodiments shown in FIGS. 2 and 11, the two lateral zones (23) of the lower surface (16) and the central zone (22) of the lower surface (16) are planar.

For the embodiments shown in FIGS. 1, 2, 10 and 11, the first protective elements (7, 8) and the second protective elements (17, 18) comprise an elastomer. In the first embodiment shown in FIGS. 1 and 2, the first protective elements (7) and the second protective elements (17) comprise ethylene propylene diene monomer as elastomer (31) and steel sheets embedded into the elastomer. The first protective elements (7) and the second protective elements (17) are attached to the main body (3, 4) by means of screws (24) passing through central holes (25) disposed in the first protective elements (7) and the second protective elements (17). In the second embodiment shown in FIGS. 10 and 11, the first protective elements (8) and the second protective elements (18) comprises polychloroprene as elastomer and steel sheets (32) bonded to the elastomer, by example in a vulcanisation process. The first protective elements (8) and the second protective elements (18) are attached to the main body (3, 4) by means of screws (26) passing through lateral holes (27) disposed in a lower steel plate (28) of the first protective elements (8) and the second protective elements (18).

The invention also relates to a support system comprising:
one support element (1) according to the first embodiment;
at least one support element (2) according to the second embodiment;
one first segment (11) of wind turbine towers, wherein the one first segment (11) is supported by means of the at least two first protective elements (7, 8) of the one support element (1) according to the first embodiment,
wherein the at least two second protective elements (17, 18) of the at least one support element (2) according to the second embodiment are disposed on the one first segment (11) having the first geometry; and
at least one additional first segment (12) of wind turbine towers, wherein the at least one additional first segment (12) is supported by means of the at least two first protective elements (7, 8) of the at least one support element (2) according to the second embodiment.

Preferably, the support system further comprises a foundation (21) configured to support the one support element (1) according to the first embodiment, the at least one support element (2) according to the second embodiment, and the one first segment (11, 12) and the at least one additional first segment (12) having the first geometry.

FIG. 6 shows a support system comprising one support element (1) according to the first preferred embodiment as shown in FIG. 1 and one support element (2) according to the second preferred embodiment as shown in FIG. 2, for stacking two segments (11, 12) of wind turbine towers, with the system described above.

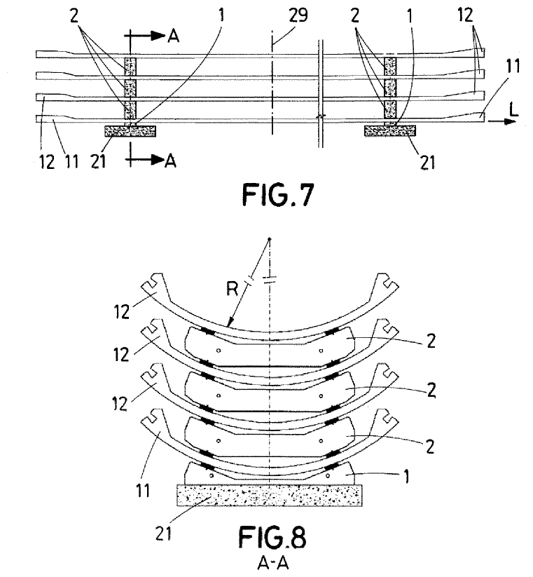

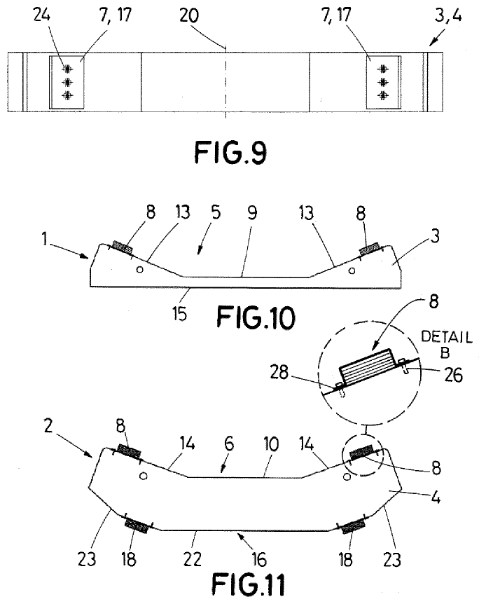

Preferably, the support system comprises:
two support elements (1) according to the first embodiment;
at least two support elements (2) according to the second embodiment,
wherein the one first segment (11) is supported by means of the at least two first protective elements (7, 8) of each of the two support elements (1) according to the first embodiment; and
wherein the at least two second protective elements (17, 18) of the at least two support elements (2) according to the second embodiment are disposed on the one first segment (11) having the first geometry; and
wherein the at least one additional first segment (12) is supported by means of the at least two first protective elements (7, 8) of the at least two support elements (2) according to the second embodiment.

wherein the two support elements (1) according to the first embodiment and the at least two support elements (2) according to the second embodiment are disposed in a symmetrical position with regard to a central section (29) of the one first segment (11) and the at least one additional first segment (12) defined in a plane perpendicular to a longitudinal direction (L) of the one first segment (11) and the at least one additional first segment (12), as shown in FIG. 7.

Preferably, the two support elements (1) according to the first embodiment and the at least two support elements (2) according to the second embodiment are centred between the central section (29) and an end of the at least one first segment (11, 12) in the longitudinal direction (L).

Preferably, the two support elements (1) according to the first embodiment and the at least two support elements (2) according to the second embodiment are displaced towards the ends of the at least one first segment (11, 12) in the longitudinal direction (L), between the central section (29) and the ends of the at least one first segment (11, 12) in the longitudinal direction (L).

In a segmented tower of a circular cross-section the segments are curved segments with substantially curved internal and external surfaces. In such a case, in the support system of the present invention described above, the thickness ratio between the summatory (t4) of the lateral thickness (t2) and the thickness (t3) of the first and/or second protective elements (7, 8, 17, 18) with respect to the central thickness (t1) of the two support elements (1) as the one described for the first embodiment and the thickness ratio between the summatory (t4) of the lateral thickness (t2) and the thickness (t3) of the first and/or second protective elements (7, 8, 17, 18) with respect to the central thickness (t1) of the two support elements (2) as the ones described for the second embodiment allow to stack the tower segments in the minimum possible height without damage or interferences between the curved segments or between the support elements and the lowest most part of the curved segments.

The summatory (t4) of the lateral thickness (t2) and the thickness (t3) of the first and/or second protective elements may optionally be between 0.05*R and 1*R, more preferably between 0.1*R and 0.8*R and even more preferably between 0.15*R and 0.7*R, wherein R is the radius of the tower segment in order to optimize the total occupied volume and avoid the abovementioned interferences.

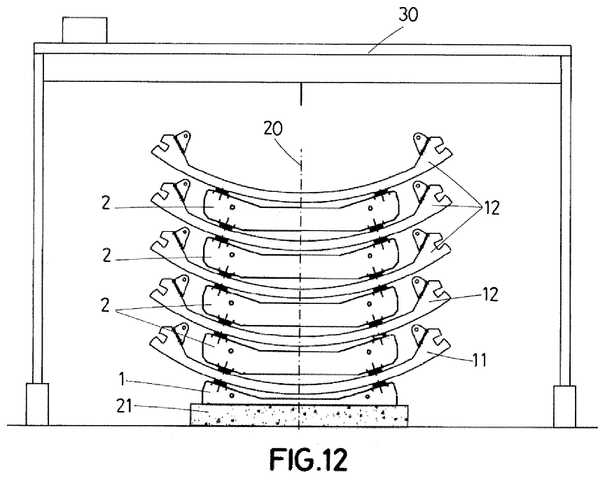

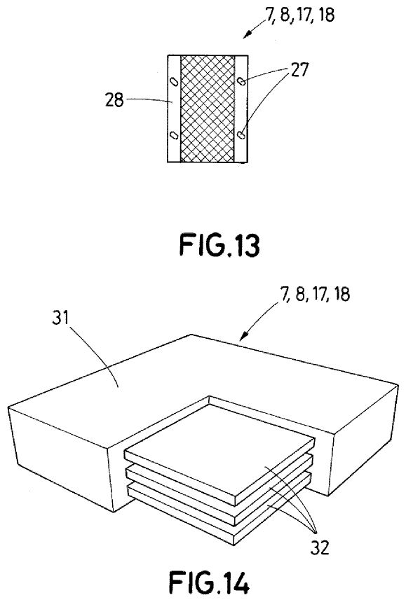

In particular, the support system described above is configured to support at least 4 segments, preferably at least 5 segments below a maximum predetermined height defined by a hoisting system or crane (30), as shown in FIG. 12.

In particular, the support system comprises support elements (1, 2) configured to support different types of segments of a wind turbine tower having as many geometries as needed.

In an embodiment, a 100-140 m high concrete tower of a wind turbine might have five to seven different types of segments respectively having five to seven different geometries (in particular, five to seven different radius of curvature). The support system comprises in this case five to seven different types of support elements configured to stack the different types of segments in different piles.

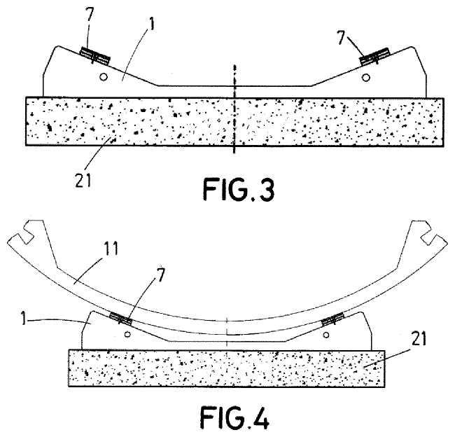

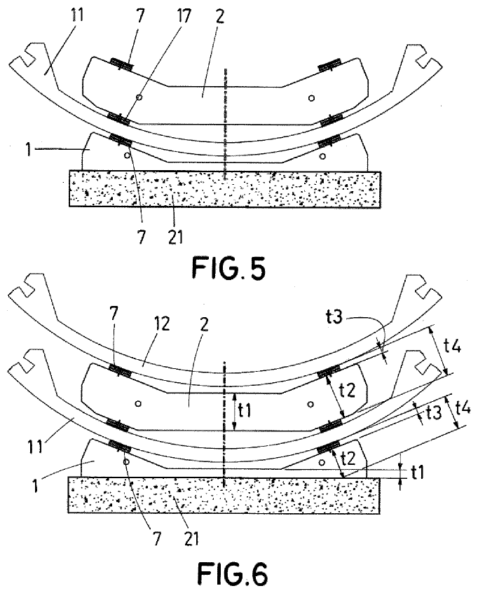

As it is shown in FIGS. 3 to 8, the invention also relates to a method of supporting at least a segment (11, 12) of wind turbine towers carried out with the support system described above, wherein the method comprises the steps of:
attaching each one of the at least two first protective elements (7, 8) to one lateral zone (13) of the upper surface (5) of the main body (3) of the one or two support elements (1) according to the first embodiment;
disposing the one first segment (11) on the at least two first protective elements (7, 8) of the one or two support elements (1) according to the first embodiment;
attaching each one of the at least two second protective elements (17, 18) to one lateral zone (23, 24) of the lower surface (16) of the main body (4) of the at least one or at least two support elements (2) according to the second embodiment;
disposing the at least one or at least two support elements (2) according to the second embodiment on the one first segment (1);
attaching each one of the at least two first protective elements (7, 8) to one lateral zone (13, 14) of the upper surface (6) of the main body (4) of the at least one or at least two support elements (2) according to the second embodiment; and
disposing the at least one additional first segment (12) on the at least two first protective elements (7, 8) of the at least one or at least two support elements (2) according to the second embodiment.

Preferably, the step of disposing the one first segment (11) on the at least two first protective elements (7, 8) of the one or two support elements (1) according to the first embodiment can be carried out before, after or simultaneously to the step of attaching each one of the at least two second protective elements (17, 18) to one lateral zone (23, 24) of the lower surface (16) of the main body (4) of the at least one or at least two support elements (2) according to the second embodiment.

Preferably, the step of disposing the at least one or at least two support elements (2) according to the second embodiment on the one first segment (1) can be carried out before, after or simultaneously to the step of attaching each one of the at least two first protective elements (7, 8) to one lateral zone (13, 14) of the upper surface (6) of the main body (4) of the at least one or at least two support elements (2) according to the second embodiment.

Preferably, the method further comprises the following steps:
casting a foundation (21) in a stockpiling area;
disposing the one or two support elements (1, 2) according to the first embodiment on the foundation (21);
   wherein the step of disposing the one or two first segments (11) on the at least two first protective elements (7, 8) of the one or two support elements (1) according to the first embodiment is carried out after the step of disposing the one or two support elements (1) according to the first embodiment on the foundation (21).

1. Support element (1, 2) for a segment (11, 12) of wind turbine towers, wherein the support element (1, 2) comprises:
a main body (3, 4) which in turn comprises an upper surface (5, 6), wherein the upper surface (5, 6) of the main body (3, 4) comprises a central zone (9, 10) and two lateral zones (13, 14);
at least two first protective elements (7, 8), each one configured to be attached to one lateral zone (13, 14) of the two lateral zones (13, 14) of the upper surface (5, 6) of the main body (3, 4); and
wherein the at least two first protective elements (7, 8) are configured, in use, to support at least one first segment (11, 12) having a first geometry.

2. Support element (1, 2) according to claim 1, wherein the two lateral zones (13, 14) of the upper surface (5, 6) of the main body (3, 4) are two inclined surfaces.

3. Support element (1, 2) according to any one of previous claims, wherein the main body (3, 4) of the support element (1, 2) further comprises a lower surface (15, 16) and wherein the lower surface (15) of the main body (3) of the support element (1) comprises at least one planar surface.

4. Support element (1, 2) according to claim 3, wherein the lower surface (15) of the main body (3) of the support element (1) is configured to be disposed, in use, on a foundation (21).

5. Support element (2) according to any one of claim 1 or 2, wherein:
the main body (3) of the support element (2) further comprises a lower surface (16), wherein the lower surface (16) comprises at least a central zone (22) and two lateral zones (23), and
wherein the support element (2) further comprises:
at least two second protective elements (17, 18), each one configured to be attached to one lateral zone (23) of the two lateral zones (23) of the lower surface (16) of the main body (4), and
wherein the at least two second protective elements (17, 18) are configured, in use, to be disposed on the at least one first segment (11, 12) having the first geometry.

6. Support element (1, 2) according to claim 5, wherein the two lateral zones (23) of the lower surface (16) of the main body (2) are inclined surfaces.

7. Support element (1, 2) according to claim 5, wherein the at least two first protective elements (7, 8) are disposed in a symmetrical position with regard to the central longitudinal axis (20) of the support element (1, 2).

8. Support element (1, 2) according to claim 7, wherein the at least two second protective elements (17, 18) are at least partially disposed in a vertical projection of the at least two first protective elements (7, 8).

9. Support element (1, 2) according to any one of the preceding claims, wherein the distance between the central zone (10) of the upper surface (6) and the central zone (22) of the lower surface (16) defined as a central thickness (t1) is smaller than the distance between each one of the two lateral zones (14) of the upper surface (6) and each one of the opposed two lateral zones (23) of the lower surface (16) defined as a lateral thickness (t2).

10. Support element (1, 2) according to any one of previous claims, wherein the first protective element (7, 8) or elements and/or the second protective element (17, 18) or elements comprises an elastomer.

11. Support element (1, 2) according to claim 10, wherein the elastomer is a reinforced elastomer.

12. Support element (1, 2) according to claim 11, wherein the reinforced elastomer comprises steel sheets bonded to the elastomer.

13. Support system comprising:
one support element (1) of any one of claims 1 to 4 and 9;
at least one support element (2) of any one of claims 1 to 2 and 5 to 9;
one first segment (11) of wind turbine towers, wherein the one first segment (11) is supported by means of the at least two first protective elements (7, 8) of the one support element (1) of any one of claims 1 to 4 and 9, and;
wherein the at least two second protective elements (17, 18) of the at least one support element (2) of any one of claims 1 to 2 and 5 to 9 are disposed on the one first segment (11, 12) having the first geometry;
at least one additional first segment (12) of wind turbine towers, wherein the at least one additional first segment (12) is supported by means of the at least two first protective elements (7, 8) of the at least one support element (2) of any of claims 1 to 2 and 5 to 9.

14. Support system according to claim 13, further comprising a foundation (21) configured to support the one support element (1) of any one of claims 1 to 4 and 9, the at least one support element (2) of any one of claims 1 to 2 and 5 to 9, and the one first segment (11) and the at least one additional first segment (12) having the first geometry.

15. Support system according to any one of claim 13 or 14 comprising:
two support elements (1) of any one of claims 1 to 4 and 9;
at least two support elements (2) of any one of claims 1 to 2 and 5 to 9,
wherein the one first segment (11) is supported by means of the at least two first protective elements (7, 8) of each of the two support elements (1) of any one of claims 1 to 4 and 9;
wherein the at least two second protective elements (17, 18) of the at least two support elements (2) of any one of claims 1 to 2 and 5 to 9 are disposed on the one first segment (11) having the first geometry; and
wherein the at least one additional first segment (12) is supported by means of the at least two first protective elements (7, 8) of the at least two support elements (2) of any of claims 1 to 2 and 5 to 9.

16. Support system according to any one of claims 13 to 15, wherein the one or two support elements (1) of any one of claims 1 to 4 and 9 and the at least one or at least two support elements (2) of any one of claims 1 to 2 and 5 to 9 are disposed in a symmetrical position with regard to a central section (29) of the one first segment (11) and the at least one additional first segment (12) defined in a plane perpendicular to a longitudinal direction (L) of the first segments (11, 12).

17. Support system according to any one of claims 13 to 16, wherein the system is configured to support at least four segments (11, 12), preferably at least five segments (11, 12) below a maximum predetermined height defined by a crane (30).

18. Method of supporting at least a segment (11, 12) of wind turbine towers carried out with the support system of any one of claims 13 to 17, wherein the method comprises the steps of:
attaching each one of the at least two first protective elements (7, 8) to one lateral zone (13) of the upper surface (5) of the main body (3) of the one or two support elements (1) of any one of claims 1 to 4 and 9;
disposing the one first segment (11) on the at least two first protective elements (7, 8) of the one or two support elements (1) of any one of claims 1 to 4 and 9;
attaching each one of the at least two second protective elements (17, 18) to one lateral zone (23, 24) of the lower surface (16) of the main body (4) of the at least one or at least two support elements (2) of any one of claims 1 to 2 and 5 to 9;
disposing the at least one or at least two support elements (2) of any one of claims 1 to 2 and 5 to 8 on the one first segment (1);
attaching each one of the at least two first protective elements (7, 8) to one lateral zone (13, 14) of the upper surface (6) of the main body (4) of the at least one or at least two support elements (2) of any one of claims 1 to 2 and 5 to 9; and
disposing the at least one additional first segment (12) on the at least two first protective elements (7, 8) of the at least one or at least two support elements (2) of any one of claims 1 to 2 and 5 to 9.

19. Method according to claim 18, further comprising the steps of:
casting a foundation (21) in a stockpiling area;
disposing the one or two support elements (1, 2) of any one of claims 1 to 4 and 9 on the foundation;
wherein the step of disposing the one or two first segments (11) on the at least two first protective elements (7, 8) of the one or two support elements (1) of any one of claims 1 to 4 and 9 is carried out after the step of disposing the one or two support elements (1) of any one of claims 1 to 4 and 9 on the foundation (21).
